(19) United States
(12) Patent Application Publication
(10) Pub. No.: US 2015/0237657 A1
(43) Pub. Date: Aug. 20, 2015

(54) BASE STATION, PORTABLE TERMINAL, AND WIRELESS COMMUNICATION SYSTEM

(71) Applicant: KYOCERA CORPORATION, Kyoto (JP)

(72) Inventor: Tatsuya Igarashi, Yokohama-shi (JP)

(73) Assignee: KYOCERA CORPORATION, Kyoto (JP)

(21) Appl. No.: 14/425,481

(22) PCT Filed: Sep. 3, 2013
(86) PCT No.: PCT/JP2013/073684

§ 371 Date: Mar. 3, 2015

(30) Foreign Application Priority Data
Sep. 4, 2012 (JP) 2012-193883

(51) Int. Cl. H04W 76/00; H04L 12/801; H04W 52/02; H04W 4/02

(52) U.S. Cl. CPC H04W 76/007; H04W 4/025; H04L 47/11; H04W 52/0212; H04W 4/20

(57) ABSTRACT

According to an aspect of the present invention, a base station including a wireless communication unit to perform wireless communication with portable terminals includes a disaster detecting unit that detects a disaster, an abnormality detecting unit that detects at least one of congestion and loss of function of a network, and a control unit, and the control unit controls, in a case where the disaster detecting unit detects a disaster, and the abnormality detecting unit detects at least one of congestion and loss of function of the network, the wireless communication unit to transmit a state restriction signal, which controls to transition to a state restriction mode for suppressing electricity consumption, to the portable terminal.

### TECHNICAL FIELD

The present invention relates to a base station, a portable terminal, and a wireless communication system for supporting searching of people in need of rescue in a case where a large-scale disaster by an earthquake or the like is caused.

### BACKGROUND ART

In a case where a large-scale disaster by an earthquake or the like is caused, in the disaster area, large-scale congestion or loss of network function occurs, whereby it may be impossible to call an emergency telephone number (for example, “119”). Also, in a case where a user (a person in need of rescue) is involved in building collapse, the user may be unable to voluntarily ask for rescue. Meanwhile, it is known that the survival rate of disaster victims in need of rescue significantly decreases if 72 hours elapse from occurrence of a disaster. Therefore, a technology capable of effectively searching for and rescuing people in need of rescue in a case where a large-scale disaster occurs is required.

In Patent Literature 1, there has been disclosed a rescue system including PHS terminals carried by people in need of rescue, a plurality of PHS base stations installed at important points in a site, and a base station centralized monitoring apparatus for performing centralized management of the plurality of PHS base stations. In such rescue system, the base station centralized monitoring apparatus includes a PHS terminal position grasping unit for grasping which PHS terminal of the PHS terminals is in the service area of which PHS base station, and each PHS terminal includes a rescue request signal transmitting unit for transmitting a rescue request signal, and a rescue request sounding unit for sounding a rescue request tone if the rescue request signal is transmitted.

### CITATION LIST

### Patent Literature

Patent Literature 1: Japanese Patent Application Laid-Open No. H10-302186

### SUMMARY OF THE INVENTION

### Technical Problem

However, the technology of Patent Literature 1 described above has no consideration for a possibility that large-scale congestion or loss of network function may occur in disaster areas. That is, the technology of Patent Literature 1 has no consideration for a case where people in need of rescue cannot make rescue requests through a network.

Especially, it is considered that rescue requests cannot reach request destinations due to congestion of networks (wireless networks and networks), and the congestion lasts for a long time. It also is considered a case where the functions of networks are lost due to a large-scale disaster and a long time is required to restore the networks.

Further, it is considered a case where although rescue requests can be made, it is impossible to secure helper to perform rescue activities. In this case, the rescue requests become ineffectual, and the important electricity of portable terminals capable of becoming the only means for communication with the outside in a disaster situation is wastefully lost.

Also, in Patent Literature 1 described above, it is possible to grasp PHS terminals are in the service area of which PHS base station, but it is impossible to specify the final positions of the PHS terminals in the service areas. Especially, in a case where people in need of rescue are involved in building collapse and the like and thereby cannot voluntarily make rescue requests, more time is required for searching for the people in need of rescue.

The present invention was made in view of this problem, and an object of the present invention is to provide a base station, a portable terminal, and a wireless communication system capable of effectively supporting searching and rescuing of people in need of rescue including people who are in need of rescue but cannot voluntarily make rescue requests while considering a possibility that large-scale congestion or loss of functions of networks may occur in disaster areas.

### Solution to Problem

According to an aspect of the present invention, a base station including a wireless communication unit to perform wireless communication with portable terminals includes a disaster detecting unit that detects a disaster, an abnormality detecting unit that detects at least one of congestion and loss of function of a network, and a control unit, and the control unit controls, in a case where the disaster detecting unit detects a disaster, and the abnormality detecting unit detects at least one of congestion and loss of function of the network, the wireless communication unit to transmit a state restriction signal, which controls to transition to a state restriction mode for suppressing electricity consumption, to the portable terminal.

In the above-described aspect, after the state restriction signal is transmitted, the control unit may control the wireless communication unit to transmit a restriction release signal for releasing the state restriction mode, on the basis of a predetermined condition.

In the above-described aspect, after the state restriction signal is transmitted, the control unit may control the wireless communication unit to transmit a rescue support start signal to the portable terminals, on the basis of a predetermined condition and controls to transition to a notification mode for notifying the positions of the portable terminals.

In the above-described aspect, in a case where the disaster detecting unit detects a disaster and the abnormality detecting unit detects at least one of congestion and loss of function of the network, before the control unit controls the wireless communication unit to transmit the state restriction signal, the control unit may control the wireless communication unit to transmit an advance notice signal for notifying the portable terminals that the base station will control the portable terminals to transition to the state restriction mode.

In the above-described aspect, the wireless communication unit may have an adaptive array function, and wherein, in a case where the control unit controls the wireless communication unit to transmit the rescue support start signal, the control unit may control the wireless communication unit to use the adaptive array function and to restrict the directivity of an electric wave to transmit the rescue support start signal, to a predetermined direction.

In the above-described aspect, the base station may include: a memory that stores the identification data of the portable terminals, wherein, in a case where it is impossible to register the positions of the portable terminals through the network, the control unit may store the identification data of portable terminals wirelessly connected to the base station, in the memory.

Meanwhile, according to another aspect of the present invention, a portable terminal including a wireless communication unit to perform wireless communication with a base station includes: a notifying unit configured to notify the position of the portable terminal; and a control unit, and in a case of receiving a state restriction signal from the base station, the control unit controls to transition to a state restriction mode for suppressing electricity consumption, and wherein, in the state restriction mode, if a restriction release signal is received from the base station, the control unit finishes the state restriction mode.

In the above-described aspect, in the state restriction mode, the control unit may restrict a function of the portable terminal and lengthen an intermittent reception cycle of the wireless communication unit.

In the above-described aspect, in the state restriction mode, if a rescue support start signal is received from the base station, the control unit may control to transition to a notification mode for controlling the notifying unit to notify the position of the portable terminal.

In the above-described aspect, the base station may include an operation unit that receives operations of a user, wherein in a case of receiving an advance notice signal transmitted prior to the state restriction signal, it may be possible to reject the portable terminal to transition to the state restriction mode, by the operation unit.

Meanwhile, according to another aspect of the present invention, a wireless communication system including a portable terminal and a base station each of which includes a wireless communication unit, wherein the base station includes: a disaster detecting unit that detects a disaster; an abnormality detecting unit that detects at least one of congestion and loss of function of a network, and a control unit that controls, in a case where the disaster detecting unit detects a disaster, and the abnormality detecting unit detects at least one of congestion and loss of function of the network, the wireless communication unit to transmit a state restriction signal, which controls to transition to a state restriction mode for suppressing electricity consumption, to the portable terminal, and wherein the portable terminal includes: a notifying unit configured to notify the position of the portable terminal, and a terminal control unit that controls, in a case of receiving the state restriction signal from the base station, the portable terminal to transition to a state restriction mode for suppressing electricity consumption and to finish the state restriction mode if a restriction release signal is received from the base station when the portable terminal is in the state restriction mode.

In the above-described aspect, after the state restriction signal is transmitted, the control unit may control the wireless communication unit to transmit a rescue support start signal to the portable terminal on the basis of a predetermined condition, and to transition to a notification mode for notifying the position of the portable terminal, and wherein, in a case of receiving the rescue support start signal from the base station, the terminal control unit may control the portable terminal to transition to the notification mode.

### ADVANTAGEOUS EFFECT OF THE INVENTION

According to the present invention, it is possible to provide a base station, a portable terminal, and a wireless communication system capable of effectively supporting searching and rescuing of people in need of rescue including people who are in need of rescue but cannot voluntarily make rescue requests.

### BRIEF DESCRIPTION OF DRAWINGS

FIG. 1 is an explanatory view for explaining a schematic configuration of a wireless communication system according to an embodiment.

FIG. 2 is a block diagram illustrating a schematic configuration of a base station shown in FIG. 1.

FIG. 3 is a block diagram illustrating a schematic configuration of a portable terminal shown in FIG. 1.

FIG. 4 is a sequence diagram for explaining an operation of the wireless communication system shown in FIG. 1.

### DESCRIPTION OF EMBODIMENTS OF THE INVENTION

Hereinafter, a preferred embodiment of the present invention will be described in detail with reference to the accompanying drawings. The sizes, materials, specific numerical values and the like described in the embodiment are just exemplary so as to facilitate understanding of the present invention, and are not to limit the invention, unless otherwise mentioned. Further, in the specification and the drawings, the elements having the substantially same function and configuration will be designated with the same reference symbols and the overlapped descriptions thereof will be omitted. In addition, the elements that are not directly related to the invention will not be shown.

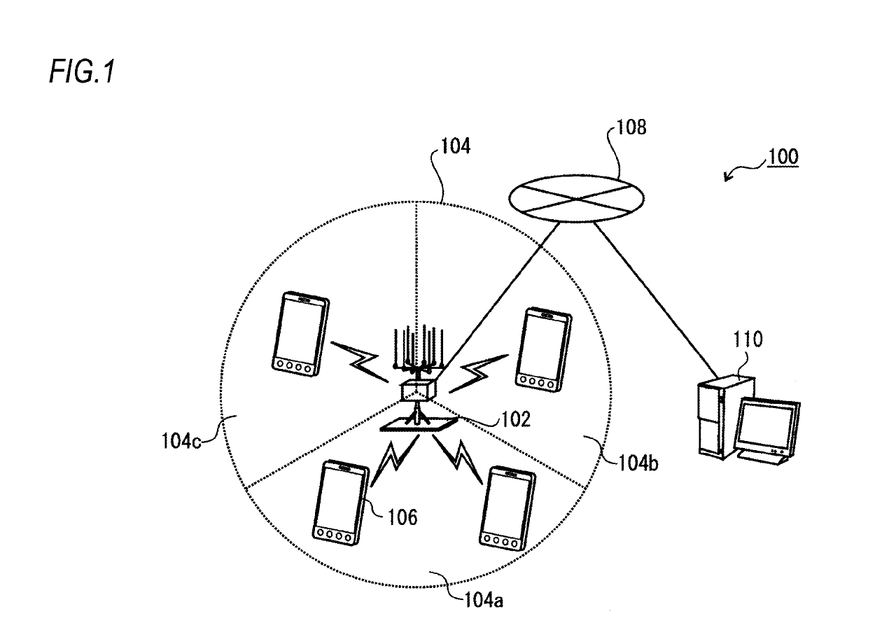

FIG. 1 is an explanatory view for explaining a schematic configuration of a wireless communication system 100 according to an embodiment. As shown in FIG. 1, the wireless communication system 100 includes a base station 102 and a plurality of portable terminals 106 (one of which is representatively designated with a reference symbol) which is positioned inside the cell 104 of the base station 102 and is wirelessly connected to the base station 102 for communication. In the present embodiment, the cell 104 is divided into three sectors 104a, 104b, and 104c. The base station 102 is connected to a network 108 which is configured by an ISDN (integrated services digital network) line, the Internet, a dedicated line, and the like, thereby establishing communication with other base stations (not shown) and performing voice communication between the portable terminals 106 and other parties. The communication establishment is managed by a relay server 110.

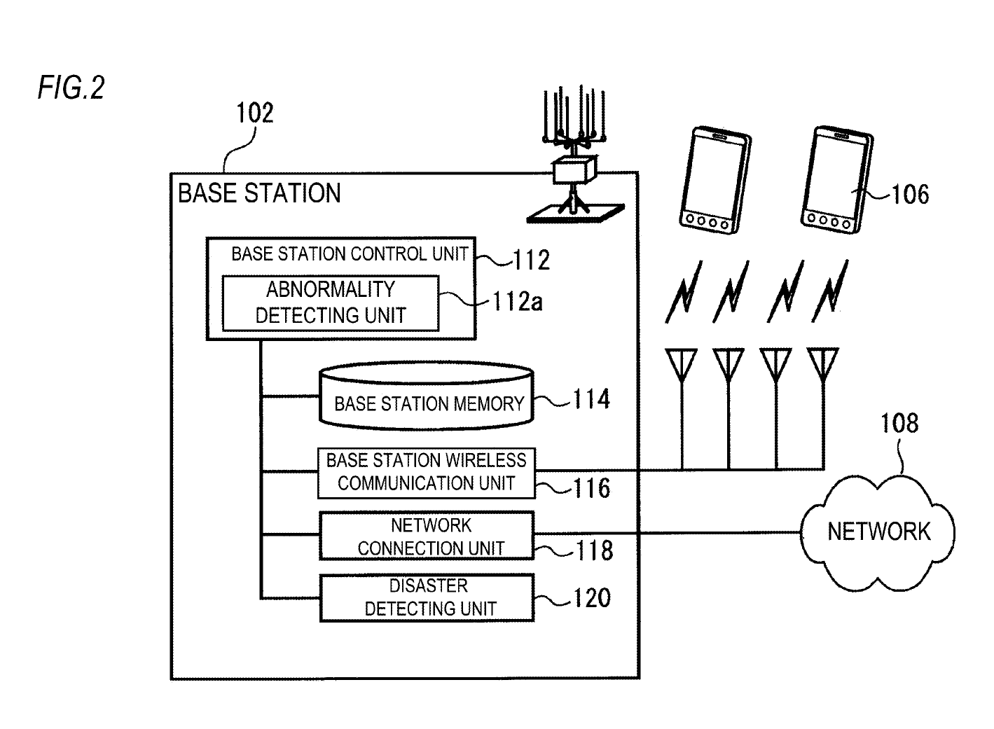

FIG. 2 is a block diagram illustrating a schematic configuration of the base station 102. As shown in FIG. 2, the base station includes a base station control unit 112 which is configured so as to include a central processing unit (CPU), and a base station memory 114 which is configured by a ROM, a RAM, a flash memory, and the like. The base station control unit 112 executes programs stored in the base station memory 114, thereby controlling and managing the corresponding base station 102. The base station memory 114 stores programs and various data.

The base station 102 includes a base station wireless communication unit 116 for performing wireless communication with the portable terminals 106. The base station wireless communication unit 116 includes a plurality of antennas (an adaptive array antenna) and has an adaptive array function. The base station wireless communication unit 116 adjusts the phase of an electric wave using the plurality of antennae during activation of the adaptive array function, thereby controlling the directivity of the electric wave. Further, the base station 102 includes a network connection unit 118 which is connected to the network 108.

The base station 102 includes a disaster detecting unit 120 for detecting disasters. The disaster detecting unit 120 is implemented, for example, by an acceleration sensor capable of measuring magnitudes of earthquakes. In this case, in a case where a measured earthquake magnitude is equal to or greater than a predetermined threshold value, it is detected that a disaster has occurred. Also, disasters to be detected are not limited only to earthquakes, and the disaster detecting unit may be configured so as to detect floods, typhoons, seismic sea waves, or the like. Also, the base station may be notified of occurrence of disasters from the outside, without detecting disasters for itself. Also, in the present embodiment, the above described base station control unit 112 serves as an abnormality detecting unit 112a for detecting congestion and loss of function of the network 108. The abnormality detecting unit 112a detects congestion of the network 108, wireless network congestion, and loss of function of the network 108.

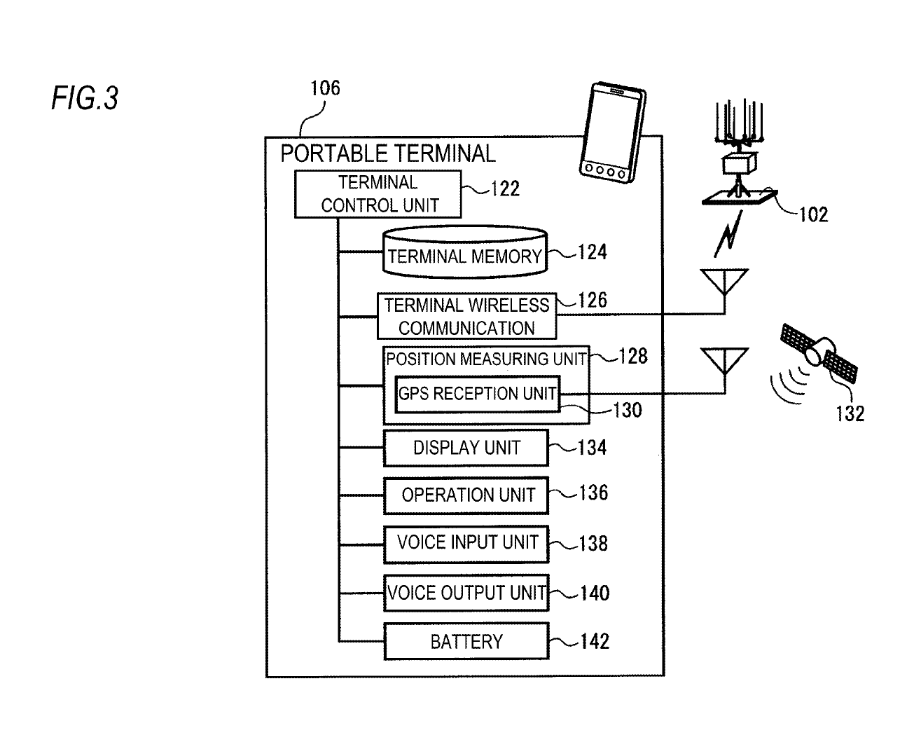

FIG. 3 is a block diagram illustrating a schematic configuration of a portable terminal 106. As shown in FIG. 3, a portable terminal 106 includes a terminal control unit 122 which is configured so as to include a central processing unit (CPU) and a terminal memory 124 which is configured by a ROM, a RAM, a flash memory, and the like. The terminal control unit 122 executes programs stored in the terminal memory 124, thereby controlling and managing the corresponding portable terminal. The terminal memory 124 stores programs and various data.

The portable terminal 106 includes a terminal wireless communication unit 126 for performing wireless communication with the base station 102. Further, the portable terminal 106 includes a position measuring unit 128 for measuring the position of the corresponding terminal. The position measuring unit 128 is configured so as to include a GPS reception unit 130, and receives a signal from a GPS satellite 132, thereby measuring the position of the corresponding terminal. Also, for example, the position measuring unit 128 may acquire position information of three base stations and measure the position of the corresponding terminal by three-point measurement, without including the GPS reception unit 130.

The portable terminal 106 includes a display unit 134 for displaying images for a user, and an operation unit 136 for receiving user's operations. The display unit 134 is configured by a display such as a liquid crystal display or an EL display, and a controller for the display. The operation unit 136 is configured by a touch panel, a keyboard, cross keys, a joy stick, and the like. Also, as the display unit 134 and the operation unit 136, a touch panel display may be configured by a liquid crystal display and a touch panel.

The portable terminal 106 includes a voice input unit 138 which is configured by a voice recognizing unit such as a microphone, and a voice output unit 140 which is configured by a voice output unit such as a speaker. During voice communication, if the voice of the user is input, the voice input unit 138 converts the voice into an electric signal processable in the portable terminal 106. The voice output unit 140 converts a received voice signal of a voice communication partner into a voice, and outputs the voice, and outputs an incoming call tone, an operation tone, a warning tone, an alarm tone, and the like. Also, the portable terminal 106 includes a battery 142 for supplying electricity to the corresponding terminal.

Also, the display unit 134 and the voice output unit 140 described above serve as a notifying unit capable of notifying the position of the corresponding portable terminal 106. Specifically, the display unit 134 blinks (flashes) on and off or a sound is output from the voice output unit 140 at the maximum volume, thereby notifying the position of the corresponding portable terminal 106. It is also effective to produce a howl between the voice input unit 138 and the voice output unit 140, thereby notifying the position of the corresponding portable terminal 106.

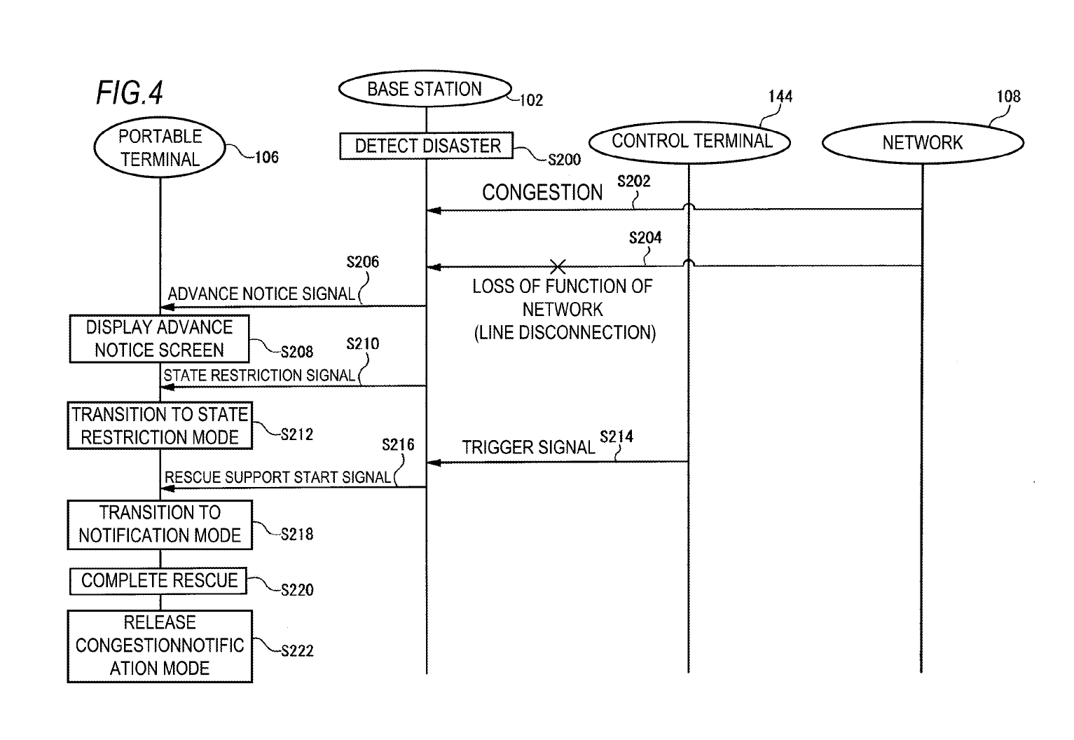

FIG. 4 is a sequence diagram for explaining an operation of the wireless communication system 100. In a case where a large-scale disaster occurs, the wireless communication system 100 performs the following illustrative operation for supporting searching and rescuing of people being in need of rescue and involved in building collapse or the like.

In a case where a large-scale disaster occurs, the disaster detecting unit 120 of the base station 102 detects the disaster (STEP S200). In the early state of the disaster, occurrence of congestion of the network 108 or loss of function of the network 108 due to the disaster is assumed. In this case, the abnormality detecting unit 112a detects congestion (STEP S202) or loss of function of the network 108 (STEP S204). Also, loss of function of the network 108 represents a state where lines constituting the network 108 have been cut, whereby the network 108 does not work.

In the base station 102, in a case where the disaster detecting unit 120 detects a disaster, and the abnormality detecting unit 112a detects any abnormality described above, the base station control unit 112 controls the base station wireless communication unit 116 to transmit an advance notice signal (STEP S206). The advance notice signal is a signal for notifying that the base station will control the portable terminals to transition to a state restriction mode, in advance, and is transmitted to the portable terminals 106 being under control of the base station (the portable terminals 106 positioned inside the cell 104 of the base station 102).

If the advance notice signal is received by the terminal wireless communication unit 126 of each portable terminal 106, an image for notifying a transition to the state restriction mode in advance is displayed on the display unit 134 of the corresponding portable terminal (STEP S208). Also, in a case where a user is not in need of rescue (a case where a user is not requiring rescue), the user can use an operation unit 136 to reject transition of a corresponding portable terminal 106 to the state restriction mode. Therefore, it is possible to prevent a transition to the state restriction mode if it is unnecessary, and it is possible to improve usability.

In the base station 102, after the advance notice signal is transmitted, the base station control unit 112 controls the base station wireless communication unit 116 to transmit a state restriction signal to the portable terminals 106 being under control of the base station (STEP S210). The state restriction signal is a signal for controlling the portable terminals 106 being under control of the base station to transition to the state restriction mode for suppressing electricity consumption. If the state restriction signal is received by the terminal wireless communication unit 126 of each portable terminal 106, as long as the corresponding portable terminal was rejected to the transition to the state restriction mode at a time of reception of the advance notice signal, the terminal control unit 122 controls to transition to the state restriction mode (STEP S212).

In the state restriction mode, all functions of each portable terminal 106 are restricted in principle. That is, not only outgoing calls and incoming calls but also operations on all other applications are restricted. The only function which can be performed in the state restriction mode is an intermittent reception function of waiting for a predetermined signal from the base station 102. However, in the state restriction mode, the intermittent reception cycle of each terminal wireless communication unit 126 is set to be significantly longer than a normal cycle (intermittent reception with a long cycle). Also, even after the transition to the state restriction mode, user may use an operation unit 136 to release the state restriction mode.

According to the above described configuration, it is possible to minimize electricity consumption of a battery 142 until a corresponding portable terminal transitions to a notification mode to be described below. Also, the base station 102 can perform the above described operation of controlling each portable terminal 106 being under control of the base station to transition to the state restriction mode, in a state where the base station is isolated from the network 108 (the base station 102 on its own). However, in a case where the base station 102 does not work as a part of the network 108, each base station control unit 112 cannot refer to a position registration database connected through the network 108. Therefore, in a case where it is impossible to register the positions of the portable terminals 106 through the network 108 (it is impossible to refer to the position registration database), the base station control unit 112 may store the identification data of the portable terminals 106 wirelessly connected to the corresponding base station 102, in the base station memory 114, and locally register the positions of the portable terminals 106 in the base station 102. As a result, the base station 102 can perform the above described operation on its own.

Also, in the present embodiment, in a case where the disaster detecting unit 120 detects a disaster and the abnormality detecting unit 112a detects congestion (STEP S202) or loss of function of the network 108 (STEP S204), the above described operation is performed. However, even in a case where any of them is not detected, the base station may perform the operation of controlling the portable terminals 106 being under control of the base station to transition to the state restriction mode. This is, since even in a case where a disaster is detected but congestion or loss of function of the network 108 is not detected, it is considered a case where immediately after occurrence of a large-scale disaster, it is impossible to secure manpower, and thus even if it is possible to make rescue requests, it is impossible to perform rescuing.

After the portable terminals 106 transitions to the state restriction mode, if it becomes possible to secure manpower and thus rescuing becomes possible, a helper operates a control terminal 144 to transmit a trigger signal for informing that situation to the base station 102 (STEP S214). The control terminal 144 may be a dedicated terminal or may be a general terminal. The trigger signal can include information on areas where rescuing is possible. If the trigger signal is received, in the base station 102, the base station control unit 112 controls the base station wireless communication unit 116 to transmit a rescue support start signal to the portable terminals 106 being under control of the base station (STEP S216). The rescue support start signal is a signal for controlling the portable terminals 106 to transition to the notification mode for notifying the positions of the corresponding portable terminals.

In the present embodiment, in order to make it possible to start searching and rescuing from a rescue area where it has been possible to secure manpower and thus rescuing has become possible (a rescue area where manpower have been provided out), the base station control unit 112 controls the base station wireless communication unit 116 to restrict the transmission area of the rescue support start signal. Specifically, the transmission area of the rescue support start signal may be set for each of the sectors 104a, 104b, and 104c, on the basis of the trigger signal from the control terminal 144. Further, in a case where the base station wireless communication unit 116 has an adaptive array function, the base station control unit 112 can restricts the directivity of an electric wave to transmit the rescue support start signal, to a predetermined direction, on the basis of the trigger signal from the control terminal 144.

Therefore, it is possible to divide the rescue area into smaller areas. As a result, it is possible to intensively search and rescue of each rescue area. Also, since it is possible to appropriately control only portable terminals 106 being in the rescue area to transition to the notification mode, and other portable terminals 106 being in rescue areas where searching and rescuing have not started do not release the state restriction mode, there is no fear of wasteful consumption of their electricity.

Also, in the present embodiment, an instruction to transition to the notification mode is output from the control terminal 144 to the base station 102. However, the present invention is not limited thereto. It may be possible to arbitrarily set a condition where the base station control unit 112 controls the portable terminals 106 being under control of the base station to transition to the notification mode. For example, the base station control unit 112 may be configured to transmit a restriction release signal for releasing the state restriction mode in a case where congestion or loss of function of the network is recovered. In this case, immediately after the network is recovered, people in need of rescue can make rescue requests. Also, the base station may be configured so as to transmit the restriction release signal for releasing the state restriction mode or the rescue support start signal for performing control to transition to the notification mode, if a predetermined time elapses from detection of a disaster. Immediately after a large-scale disaster occurs, it can be assumed that the network is abnormal or it is impossible to secure manpower. However, after the predetermined time (for example, 24 hours), it can be assumed that it is possible to perform rescuing.

If a portable terminal 106 receives the rescue support start signal of STEP S216 by the terminal wireless communication unit 126, the terminal control unit 122 control to transition to the notification mode (STEP S218). In the notification mode, the display unit 134 serving as a notifying unit blinks (flashes) on and off, or the voice output unit 140 serving as a notifying unit outputs a sound at the maximum volume, or a howl is produced between the voice input unit 138 and the voice data 400 serving as a notifying unit, whereby the position of the corresponding portable terminal 106 is notified. This notification is performed regardless of the intention of the user (a person being in need of rescue). Therefore, if the person being in need of rescue is rescued (STEP S220), it is possible to release the notification mode using the operation unit 136 (STEP S222).

Also, in the present embodiment, the base station 102 is configured so as to transmit the rescue support start signal to transition to the notification mode with releasing of the state restriction mode. However, the present invention is not limited thereto. The portable terminals may only release the state restriction mode. That is, if the base station 102 transmits the restriction release signal, the portable terminals 106 may only stop intermittent reception with the long cycle, without performing the above described notification. Even in this configuration, it is possible to suppress electricity consumption of the portable terminals 106 of people being in need of rescue until rescuing becomes possible.

Also, in the notification mode, each portable terminal 106 may transmit (notify) the position of the corresponding portable terminal measured by the position measuring unit 128, to the outside through the terminal wireless communication unit 126. p According to the above described configuration, (1) regardless of the states of people being need of help, and (2) regardless of congestion or loss of function of the network 108 (the base station 102 can perform the above described operation on its own), (3) it is possible to minimize electricity consumption of the portable terminals 106 of people being in need of rescue until rescuing becomes possible, and (4) if rescuing becomes possible, it is possible to control the portable terminals 106 of people being in need of rescue to notify their positions. Therefore, it is possible to effectively supporting searching and rescuing of people in need of rescue including people who are in need of rescue but cannot voluntarily make rescue requests.

Although the preferred embodiment of the present invention has been described, it is apparent that the present invention is not limited to the above described embodiment. Also, it is obvious that those skilled in the art can devise various alterations or modifications within the scope as set forth in the claims, and it is to be understood that these alterations and modifications belong, as a matter of course, to the technical scope of the present invention.

This application is based on Japanese Patent Application No. 2012-193883, filed on Sep. 4, 2012, the content of which is incorporated herein by reference.

### INDUSTRIAL APPLICABILITY

The present invention can be used in base stations, portable terminals, and wireless communication systems for supporting searching of people in need of rescue in a case where a large-scale disaster is caused by an earthquake or the like.

### DESCRIPTION OF REFERENCE NUMERALS

100: WIRELESS COMMUNICATION SYSTEM,
102: BASE STATION,
104: CELL,
104a, 104b, 104c: SECTOR,
106: PORTABLE TERMINAL,
108: NETWORK,
110: RELAY SERVER,
112: BASE STATION CONTROL UNIT,
112a: ABNORMALITY DETECTING UNIT,
114: BASE STATION MEMORY,
116: BASE STATION WIRELESS COMMUNICATION UNIT,
118: NETWORK CONNECTION UNIT,
120: DISASTER DETECTING UNIT,
122: TERMINAL CONTROL UNIT,
134: TERMINAL MEMORY,
126: TERMINAL WIRELESS COMMUNICATION UNIT,
128: POSITION MEASURING UNIT,
130: GPS RECEPTION UNIT,
132: GPS SATELLITE,
134: DISPLAY UNIT,
136: OPERATION UNIT,
138: VOICE INPUT UNIT,
140: VOICE OUTPUT UNIT,
142: BATTERY,
144: CONTROL TERMINAL

1. A base station, which includes a wireless communication unit to perform wireless communication with a portable terminal, comprising:
a disaster detecting unit that detects a disaster;
an abnormality detecting unit that detects at least one of congestion and loss of function of a network; and
a control unit,
wherein in a case where the disaster detecting unit detects a disaster and the abnormality detecting unit detects at least one of congestion and loss of function of the network, the control unit controls the wireless communication unit to transmit a state restriction signal, which controls to transition to a state restriction mode for suppressing electricity consumption, to the portable terminal.

2. The base station according to claim 1,
wherein, after the state restriction signal is transmitted, the control unit controls the wireless communication unit to transmit a restriction release signal for releasing the state restriction mode, on the basis of a predetermined condition.

3. The base station according to claim 1,
wherein, after the state restriction signal is transmitted, the control unit controls the wireless communication unit to transmit a rescue support start signal to the portable terminals, on the basis of a predetermined condition and controls to transition to a notification mode for notifying the positions of the portable terminals.

4. The base station according to claim 1:
wherein, in a case where the disaster detecting unit detects a disaster and the abnormality detecting unit detects at least one of congestion and loss of function of the network, before the control unit controls the wireless communication unit to transmit the state restriction signal, the control unit controls the wireless communication unit to transmit an advance notice signal for notifying the portable terminals that the base station will control the portable terminals to transition to the state restriction mode.

5. The base station according to claim 1,
wherein the wireless communication unit has an adaptive array function, and wherein, in a case where the control unit controls the wireless communication unit to transmit the rescue support start signal, the control unit controls the wireless communication unit to use the adaptive array function and to restrict the directivity of an electric wave to transmit the rescue support start signal, to a predetermined direction.

6. The base station according to claim 1, further comprising:
a memory that stores the identification data of the portable terminals,
wherein, in a case where it is impossible to register the positions of the portable terminals through the network, the control unit stores the identification data of portable terminals wirelessly connected to the base station, in the memory.

7. A portable terminal, which includes a wireless communication unit to perform wireless communication with a base station, comprising:
a notifying unit configured to notify the position of the portable terminal; and
a control unit,
wherein in a case of receiving a state restriction signal from the base station, the control unit controls to transition to a state restriction mode for suppressing electricity consumption, and
wherein, in the state restriction mode, if a restriction release signal is received from the base station, the control unit finishes the state restriction mode.

8. The portable terminal according to claim 7,
wherein, in the state restriction mode, the control unit restricts a function of the portable terminal and lengthens an intermittent reception cycle of the wireless communication unit.

9. The portable terminal according to claim 7, wherein:
wherein, in the state restriction mode, if a rescue support start signal is received from the base station, the control unit controls to transition to a notification mode for controlling the notifying unit to notify the position of the portable terminal.

10. The portable terminal according to claim 7, further comprising:
an operation unit that receives operations of a user,
wherein in a case of receiving an advance notice signal transmitted prior to the state restriction signal, it is possible to reject the portable terminal to transition to the state restriction mode, by the operation unit.

11. A wireless communication system comprising a portable terminal and a base station each of which includes a wireless communication unit,
wherein the base station includes:
a disaster detecting unit that detects a disaster;
an abnormality detecting unit that detects at least one of congestion and loss of function of a network, and
a control unit that controls, in a case where the disaster detecting unit detects a disaster, and the abnormality detecting unit detects at least one of congestion and loss of function of the network, the wireless communication unit to transmit a state restriction signal, which controls to transition to a state restriction mode for suppressing electricity consumption, to the portable terminal, and
wherein the portable terminal includes:
a notifying unit configured to notify the position of the portable terminal, and
a terminal control unit that controls, in a case of receiving the state restriction signal from the base station, the portable terminal to transition to a state restriction mode for suppressing electricity consumption and to finish the state restriction mode if a restriction release signal is received from the base station when the portable terminal is in the state restriction mode.

12. The wireless communication system according to claim 11,
wherein, after the state restriction signal is transmitted, the control unit controls the wireless communication unit to transmit a rescue support start signal to the portable terminal on the basis of a predetermined condition, and to transition to a notification mode for notifying the position of the portable terminal, and
wherein, in a case of receiving the rescue support start signal from the base station, the terminal control unit controls the portable terminal to transition to the notification mode.
